(19) United States
(12) Patent Application Publication
(10) Pub. No.: US 2026/0102025 A1
(43) Pub. Date: Apr. 16, 2026

(54) CHAMFERED BLENDING JAR WITH ELONGATE RIDGES

(71) Applicant: BLENDTEC, INC., Orem, UT (US)

(72) Inventors: David J. Throckmorton, Mapleton, UT (US); Calvin W. Cox, Eagle Mountain, UT (US); Jeffery A. Freeman, Canton, MI (US)

(73) Assignee: BLENDTEC, INC., Orem, UT (US)

(21) Appl. No.: 18/914,425

(22) Filed: Oct. 14, 2024

(51) Int. Cl. A47J 43/07; A47J 43/046

(52) U.S. Cl. CPC A47J 43/0727; A47J 43/046

(57) ABSTRACT

A blender apparatus can include a base that includes a motor and one or more controls to effectuate the motor. The blender apparatus can include a blade rotatably connected to the motor. The blender apparatus can additionally include a container positionable on the base and including an interior volume around the blade, the container including: a first container end; a second container end opposite the first container end; a plurality of interior sidewalls spanning between the first container end and the second container end; a first plurality of flow manipulators extending longitudinally between the first container end and the second container end; and a second plurality of flow manipulators separate from the first plurality of flow manipulators and positionable adjacent the blade, the second plurality of flow manipulators being attached to the plurality of interior sidewalls and extending inward in a direction toward the blade.

### FIELD

This disclosure relates generally to a blender apparatuses, blending systems, and methods of blending foodstuff.

### BACKGROUND

Food processors and blending machines are widely used by the general retail population and various commercial industries (e.g., the commercial food and beverage industries). Smoothies, coffees, shakes, dairy drinks, nutritional beverages, sauces, purees, food mixes, recipe dicing, product pulverization, and the like can be made with food processors or blending machines. Ingredients and end products can, therefore, vary widely depending on the application of use.

In some examples, blending time and/or consistency of blended product can determine how useful, effective, or efficient a blending device or food processor is. For example, inconsistency in a blended product can include lumps, clumps, or chunks of unmixed product that generally indicate non-uniformity in the blended product. To achieve improved consistency, blending time is traditionally increased—thereby allowing more contact with a blending blade or mixer. That is, a common tradeoff for greater blending consistency of product is increased blending time.

However, increased blending time can indicate the blending machine itself may be inefficient. Inefficiency of the blending machine can translate into other inefficiencies (e.g., inefficient serving times, inefficient cook times, etc.). Such inefficiencies can accumulate and lend to longer wait times—which can negatively affect the perception of customer service, lend to loss of sales, etc.

Limiting factors for many food processors and blending machines, in some examples, can include blending volume and blending ingredients. For instance, maintaining blending consistency (and lower blending times) at higher blending volumes (e.g., above 40 fluid ounces) can be more difficult to achieve than at more typical blending volumes (e.g., 20 to 30 fluid ounces). Higher blending volumes in some blending machines will achieve similar fluid velocity as the mixing blade, which can lend to poor mixing. On the other hand, extra low blending volumes (e.g., below 10 fluid ounces) can also present mixing challenges—often getting pushed into the bottom corners of the blending container where it can remain unmixed and stagnate beyond a fluid flow path encouraging mixing. Depending on the ingredients, the foregoing challenges of various blending volumes can be exacerbated.

The subject matter claimed herein is not limited to embodiments that solve any disadvantages or that operate only in environments such as those described above. Rather, this background is only provided to illustrate one example technology area where some embodiments described herein may be practiced.

### SUMMARY

An aspect of the present disclosure relates to a blender jar. The blender jar can include a bottom wall and a plurality of sidewalls extending upward from the bottom wall and defining a jar interior. In some examples, the upper periphery of the plurality of sidewalls define an opening into the jar interior. The blender jar can additionally include a plurality of chamfered portions respectively positioned at a plurality of corners adjoining the bottom wall and a pair of adjacent sidewalls of the plurality of sidewalls.

In some examples, the blender jar is configured to blend foodstuff having a volume of about 4 fluid ounces to about 10 fluid ounces. In particular examples, the foodstuff includes a substantially uniform blending consistency after about six seconds of blending. In one or more examples, each chamfered portion of the plurality of chamfered portions includes a transition wall having an angle greater than 20 degrees relative to the bottom wall. In at least one example, each chamfered portion of the plurality of chamfered portions includes a triangular-shaped transition wall. In specific implementations, each chamfered portion of the plurality of chamfered portions includes a base adjoining the bottom wall and a top adjoining the pair of adjacent sidewalls, the base being wider than the top. In particular examples, the blender jar can include elongate ridges extending vertically from the bottom wall toward the upper periphery. In one or more examples, during blending, each chamfered portion of the plurality of chamfered portions directs a fluid flow into an adjacent elongate ridge of the elongate ridges.

Another aspect of the present disclosure relates to a blender apparatus. The blender apparatus can include a base that includes a motor and one or more controls to effectuate the motor. The blender apparatus can include a blade rotatably connected to the motor about an axis of rotation. The blender apparatus can additionally include a container positionable on the base and including an interior volume around the blade, the container including: a floor positioned at a first container end; a plurality of sidewalls extending away from the floor toward a second container end opposite the first container end; and a plurality of elongate ridges extending between the first container end and the second container end, each elongate ridge of the plurality of elongate ridges being asymmetrically positioned relative to the axis of rotation and extending at least half of a height of the interior volume.

In some examples, the blender apparatus is configured to blend foodstuff having a volume of up to about 80 fluid ounces. In particular examples, during blending, the foodstuff is configured to form a fluid flow that impinges upon the plurality of elongate ridges and achieves a uniform blending consistency in about ten seconds or less. In one or more examples, the plurality of elongate ridges is configured to manipulate flow at an upper portion of the plurality of sidewalls adjacent the second container end. In specific implementations, each elongate ridge of the plurality of elongate ridges is respectively positioned equidistant from leading sidewall edges of the plurality of sidewalls. In at least one example, the blender apparatus can include a truncated wall between a pair of sidewalls of the plurality of sidewalls. In certain examples, an additional elongate ridge can be positioned on the truncated wall. In particular examples, the blender apparatus can further include a plurality of corner occlusions respectively positioned between the floor and pairs of adjacent sidewalls of the plurality of sidewalls.

Yet another aspect of the present disclosure relates to a blender apparatus. The blender apparatus can include a base that includes a motor and one or more controls to effectuate the motor. The blender apparatus can include a blade rotatably connected to the motor. The blender apparatus can additionally include a container positionable on the base and including an interior volume around the blade, the container including: a first container end; a second container end opposite the first container end; a plurality of interior sidewalls spanning between the first container end and the second container end; a first plurality of flow manipulators extending longitudinally between the first container end and the second container end; and a second plurality of flow manipulators separate from the first plurality of flow manipulators and positionable adjacent the blade, the second plurality of flow manipulators being attached to the plurality of interior sidewalls and extending inward in a direction toward the blade.

In some examples, the second plurality of flow manipulators includes corner occlusions that extend between adjacent interior sidewalls of the plurality of interior sidewalls. In particular examples, each flow manipulator of the second plurality of flow manipulators tapers with increasing height and lateral distance away from the blade. In at least one example, during blending: each flow manipulator of the first plurality of flow manipulators is configured to direct a fluid flow into an adjacent flow manipulator of the second plurality of flow manipulators; and each flow manipulator of the second plurality of flow manipulators is configured to direct the fluid flow toward the blade.

The subject matter claimed herein is not limited to the examples of embodiments recited above. Rather, this summary is only provided to provide an overview of various potential embodiments of this disclosure.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a schematic diagram of a blender apparatus in accordance with one or more examples of the present disclosure;

FIG. 2 illustrates a perspective view of an example blender jar in accordance with one or more examples of the present disclosure;

FIG. 3 illustrates a first side view of the blender jar of FIG. 2, according to one or more examples of the present disclosure;

FIG. 4 illustrates a second side view of the blender jar of FIG. 2, according to one or more examples of the present disclosure;

FIG. 5 illustrates a third side view of the blender jar of FIG. 2, according to one or more examples of the present disclosure;

FIG. 6 illustrates a fourth side view of the blender jar of FIG. 2, according to one or more examples of the present disclosure;

FIG. 7 illustrates a top view of the blender jar of FIG. 2, according to one or more examples of the present disclosure;

FIG. 8 illustrates a top perspective view of the blender jar of FIG. 2, according to one or more examples of the present disclosure;

FIG. 9 illustrates a cross-sectional side view of the blender jar of FIG. 2, according to one or more examples of the present disclosure;

FIG. 10 illustrates another cross-sectional side view of the blender jar of FIG. 2, according to one or more examples of the present disclosure;

FIG. 11 illustrates a cross-sectional top view of the blender jar of FIG. 2, according to one or more examples of the present disclosure;

FIG. 12 illustrates a perspective view of another example blender jar in accordance with one or more examples of the present disclosure;

FIG. 13 illustrates a top view of the blender jar of FIG. 12, according to one or more examples of the present disclosure;

FIG. 14 illustrates a cross-sectional perspective view of the blender jar of FIG. 12, according to one or more examples of the present disclosure;

FIG. 15 illustrates a perspective view of yet another example blender jar in accordance with one or more examples of the present disclosure;

FIG. 16 illustrates a top view of the blender jar of FIG. 15, according to one or more examples of the present disclosure; and

FIG. 17 illustrates a cross-sectional perspective view of the blender jar of FIG. 15, according to one or more examples of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a blender that can, with increased versatility, blend a wider spectrum of foodstuff volume than heretofore achieved by existing blenders. While many blenders can blend an average amount of foodstuff volume, no single existing blender can—with acceptable blending times and blending consistency—blend below-average volumes of foodstuff and above-average volumes of foodstuff. In contrast, the disclosed blenders can blend extra small foodstuff volumes and extra large foodstuff volumes with superior blending consistency and in unprecedented blending times.

The disclosed blenders can implement a variety of flow manipulators (e.g., one or more of corner occlusions, elongate ridges, truncated walls, etc.). In particular examples, the disclosed blenders implement a specific combination of flow manipulators that, when implemented together, can induce a particular fluid flow and/or impart certain fluid flow characteristics (which in turn can lend to improved blending consistency and/or improved blending times).

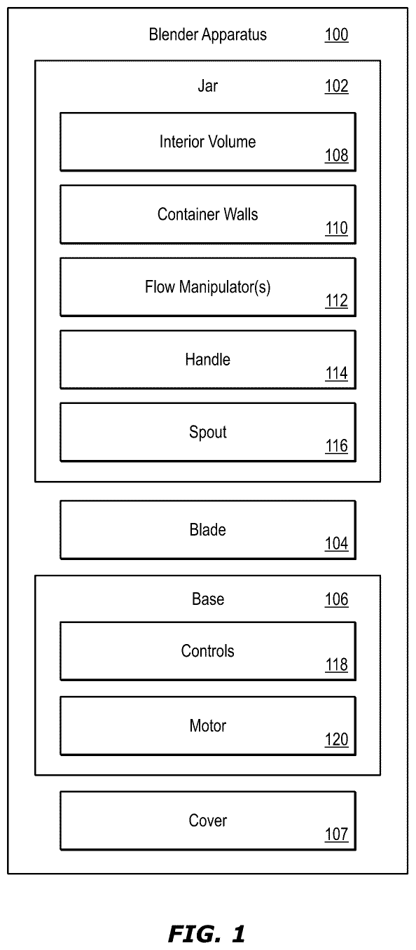

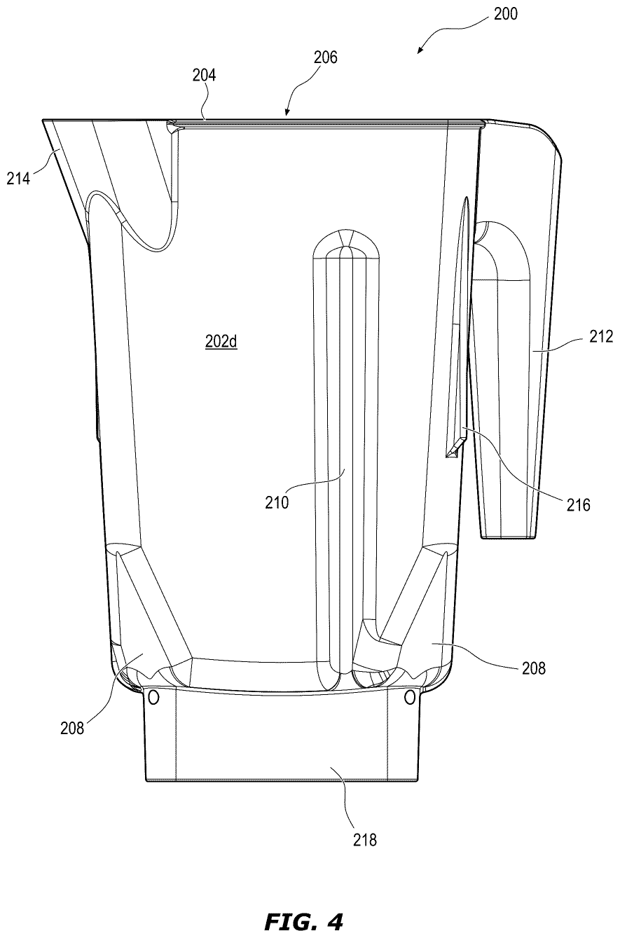

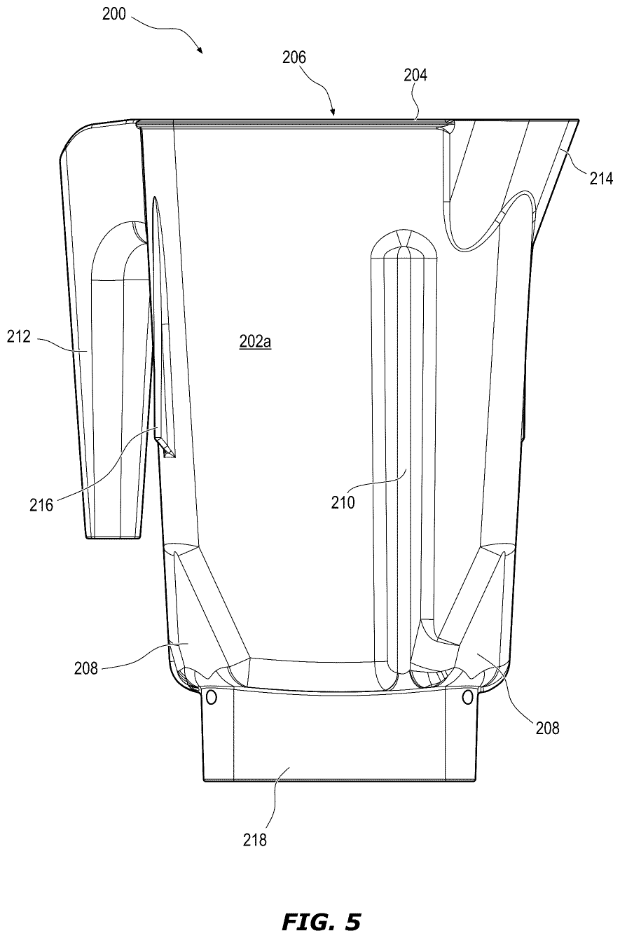

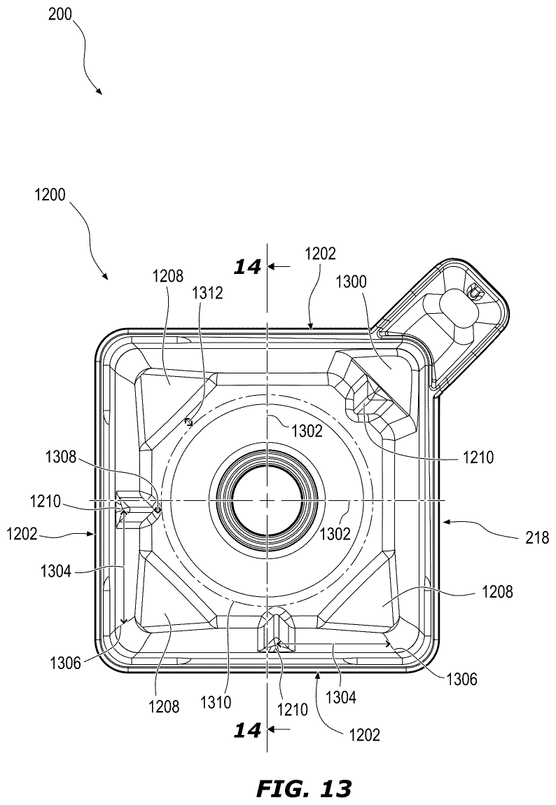

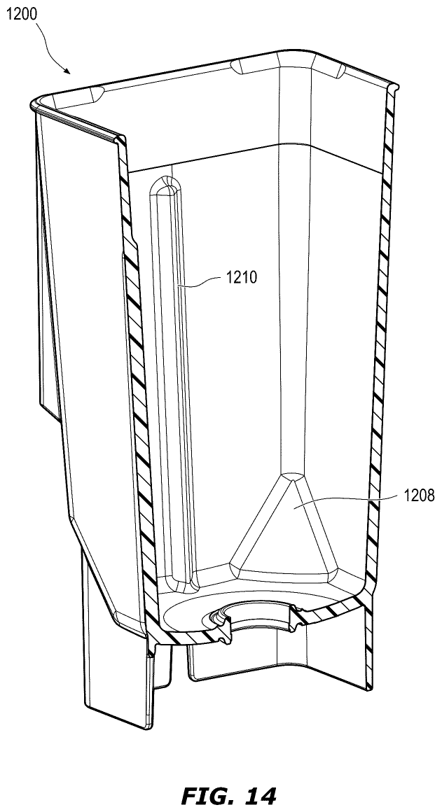

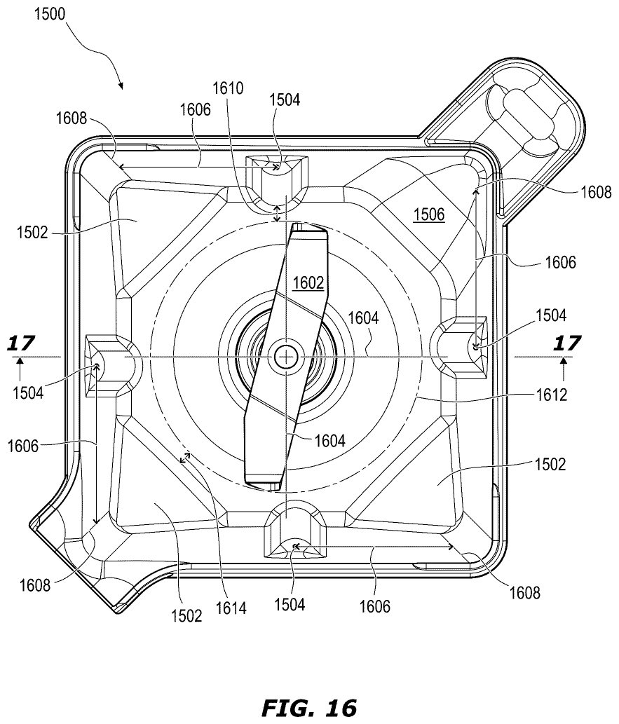

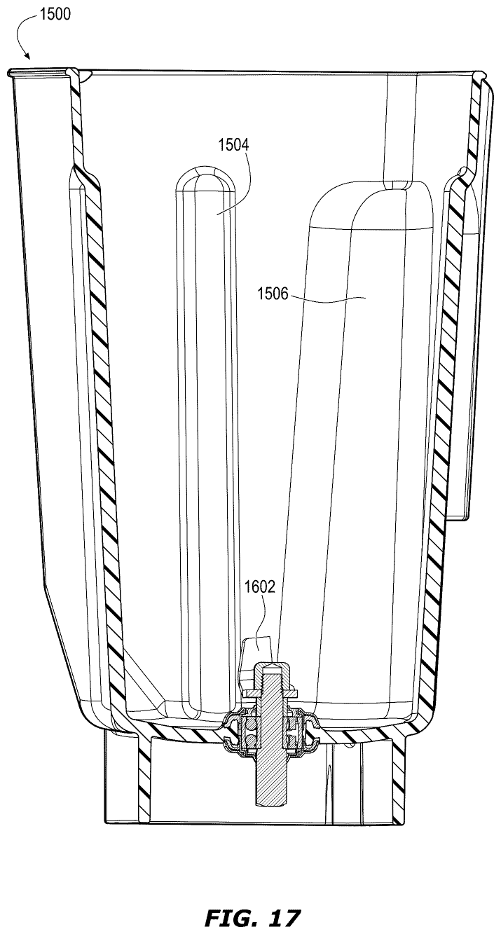

These and other embodiments are discussed below with reference to FIGS. 1-17. However, those skilled in the art, having the benefit of this disclosure, will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a schematic diagram of a blender apparatus 100 in accordance with one or more examples of the present disclosure. The blender apparatus 100 can also be referred to as a blending system, including constituent components of the blending system. As shown the blender apparatus 100 can include a jar 102, a blade 104, a base 106, and a cover 107. Each is discussed in turn.

The jar 102 can include a variety of components adapted to receive foodstuff (e.g., solids, liquids, powders, grains, creams, flakes, spices, etc. for consumption). A jar (also referred to herein as a container) can include a variety of containers, receptacles, bottles, tumblers, jugs, pitchers, vessels, flasks, bowls, flagons, canisters, etc. The jar 102 can include a variety of shapes and sizes. In certain examples, the jar 102 is substantially rectangular shaped or cylindrical shaped. Additionally or alternatively, the jar 102 can have an outer profile of one shape and an interior shape that differs from the outer profile (e.g., a circular shaped outside perimeter with rectangular shaped interior walls). A myriad number of different configurations of the jar 102 are herein contemplated, including for example, triangular, pentagonal, hexagonal, octagonal, extended rectangular, circular/cylindrical, elliptical, star-shaped, clover-shaped, or another shape apparent to those having skill in the art and the benefit of the present disclosure.

In particular examples, the jar 102, can include an interior volume 108. The interior volume 108 can include a mixing volume or a mixing area in which foodstuff can be mixed during a blending process. Additionally, in some examples, the interior volume 108 can include a storage volume or a storage area in which foodstuff can be retained (e.g., contained, bounded, isolated, insulated, sealed, preserved, warmed or chilled, at least partially covered, or enclosed). The interior volume 108 can vary widely depending on the type of the jar 102 and/or the desired application. In at least some examples, the interior volume 108 can range from about 30 fluid ounces to about 60 fluid ounces, between about 60 and about 80 fluid ounces, between about 75 and about 100 fluid ounces, or between about 90 and about 180 fluid ounces.

The actual blending volume allowed by the interior volume 108 can differ in some examples. Indeed, the blending volume of the jar 102 can range from about 2 fluid ounces to about 120 fluid ounces, about 4 fluid ounces to about 80 fluid ounces, about 6 fluid ounces to about 95 fluid ounces, about 8 fluid ounces to about 110 fluid ounces, about 4 fluid ounces to about 120 fluid ounces, or about 5 fluid ounces to about 150 fluid ounces.

In these or other examples, the interior volume 108 can be at least partially defined by container walls 110. The container walls 110 can include various sidewalls that extend between container ends. The container walls 110 can include a bottom wall or floor. The container walls 110 can work together to retain the foodstuff during a blending process. The container walls 110 can also work to retain the foodstuff before and/or after a blending process (e.g., for transport, pouring, dispensing, temporary holding, etc.).

In one or more examples, the jar 102 can include flow manipulator(s) 112. The term “flow manipulator” can refer to a component that can affect fluid flow within the interior volume 108 during a blending process. A flow manipulator, for example, can affect fluid velocity and/or direction. As another example, a flow manipulator can affect the position of a fluid vortex. In yet another example, a flow manipulator can affect fluid turbulence, fluid recursion, or fluid interactions. In specific implementations, a flow manipulator can decrease the fluid velocity relative to the blending blade rotational velocity. In another implementation, a flow manipulator can reduce or prevent fluid stagnation (e.g., where unmixed foodstuff can accumulate or reside). In at least some examples, the flow manipulator(s) 112 can include a combination of separate and discrete flow manipulators that differ from each other, including elongate ridges, truncated walls, or corner occlusions (each of which will be discussed in detail below in relation to subsequent figures).

The flow manipulator(s) 112 can be implemented with the jar 102 in a variety of ways. In some examples, the flow manipulator(s) 112 are removably attached to the jar 102 (e.g., via fasteners). In other examples, the flow manipulator(s) 112 are permanently attached to the jar 102 or otherwise integrated into the body of the jar 102. In some examples, the flow manipulator(s) 112 are attached to one or more walls of the container walls 110. For instance, the flow manipulator(s) 112 can be attached to or integrally formed within the interior sidewalls and/or the bottom floor.

The jar 102 can, in some examples, include a handle 114. The handle 114 can include a grip, hand hold, finger hold, or grabbable portion. The handle 114 can provide convenience for carrying and/or pouring the jar 102. In certain examples, the handle can include an opening stacking and nesting within other jars. In these or other examples, the handle 114 can be attached to or integrated with the body of the jar 102 (e.g., the container walls 110).

In one or more examples, the jar 102 can include a spout 116. The spout 116 can include an opening, pathway, slot, or delivery mechanism allowing for the pouring of contents from the interior volume 108. In some examples, the spout 116 can be positioned at or near an upper periphery of the container walls 110.

The jar 102 as just described can be formed with one or more of a variety of materials. In some examples, the jar 102 can include a metal material, a plastic material, an elastomer material, a composite material, a foam material, or combinations thereof. In particular examples, the jar 102 is compatible with biological materials (e.g., foodstuff for consumption). In at least some examples, the jar 102 includes non-porous surfaces, a non-stick surface or coating, etc. (e.g., for easy and convenient cleaning).

Further shown in FIG. 1, the blender apparatus 100 can include a blade 104. In some examples, the blade 104 is attached to the jar 102 (e.g., within the bottom floor of the jar 102). In other examples, the blade 104 is attached to the base 106 (in which case the jar 102 can sealingly engage with the base 106 around the blade 104). In these or other examples, the blade 104 can rotate within the interior volume 108 to blend foodstuff. It will be appreciated by those of ordinary skill in the art, having the benefit of the present disclosure, that the terms “blend” and “mix” can refer to any of a variety of specific actions—including stirring, whisking, pulverizing, aerating, frothing, churning, tossing, whipping, agitating, beating, mashing, pulping, dicing, combining, assimilating, etc. Multiple ingredients can be blended together (e.g., to form a particular combination or mixture of foodstuff). In other examples, only a single ingredient is blended, but with the purpose of changing the consistency of the ingredient (e.g., from solid ingredient chunks to minced portions). The blade 104, when activated, can perform these or other actions as the blade 104 rotates about a rotational axis. The blade 104 can be rotationally coupled to a motor (described below), such as a motor driveshaft of the motor.

In some examples, the blender apparatus 100 can include the base 106. The base 106 can include controls 118 and a motor 120 (e.g., a universal motor, induction motor, etc.). The controls 118 can include electro-mechanical features that effectuate the motor 120 (e.g., power the motor 120 on/off, provision a specific amount of electric current/voltage to the motor 120, control the revolutions per minute of the motor driveshaft, vary the torque of the motor driveshaft, disengage the driveshaft, start and/or end blending cycles, etc.). Examples of electro-mechanical features of the controls 118 can include switches, push buttons, capacitive switches, toggles, rocker switches, dials, sliders, etc. Additionally or alternatively, the controls 118 can include a touch interface (e.g., adapted to receive touch inputs, capacitive inputs, hover inputs, etc.). In some examples, the controls 118 can include a graphical user interface (e.g., for viewing/modifying blender settings, modes, cycles, programs, and the like).

In some examples, the controls 118 can include a remote control, fob, or other device to effectuate the motor 120 without direct contact to the base 106. In particular examples, the controls 118 can include a computing device (e.g., a smartphone, smartwatch, tablet, desktop computer, etc.) that is communicatively coupled to on-board controls housed within the base 106. Examples of such communication can include a wireless local area network communication, wireless area network communication, wireless personal area network communication, wide area network communication, etc. Some particular examples of wireless communication include a Wi-Fi based communication, mesh network communication, BLUETOOTH® communication, near-field communication, low-energy communication, Zigbee communication, Z-wave communication, and 6LoWPAN communication. Other forms of communication include wired connections, such as a USB connections, UART connection, USART connection, I2C connection, SPI connection, QSPI connection, etc.

Additionally shown in FIG. 1, the blender apparatus 100 can include the cover 107. The cover 107 can include a lid or cap positionable over the interior volume 108 (e.g., over the opening defined by the container walls 110 so as to help contain foodstuff within the interior volume 108 during blending). In some examples, the cover 107 can be press-fit or threaded onto an upper periphery or upper portion of the container walls 110. In certain examples, the cover 107 can block, plug, or cover the spout 116. In one or more examples, the cover 107 can include an opening sized and shaped to receive a tamper or twister (e.g., to insert inside the interior volume 108 with the cover 107 positioned in place for agitating foodstuff during blending). In certain examples, the cover 107 can include a vent (e.g., to reduce pressure build-up inside the interior volume 108). In some examples, the cover 107 can include a hand feature to manually manipulate the cover 107 on and/or off the jar 102. Still, in other examples, the cover 107 can include a connection for easily transporting the jar 102 and/or securing the jar 102 to another element (e.g., backpack, suitcase, lanyard, carabiner, etc.).

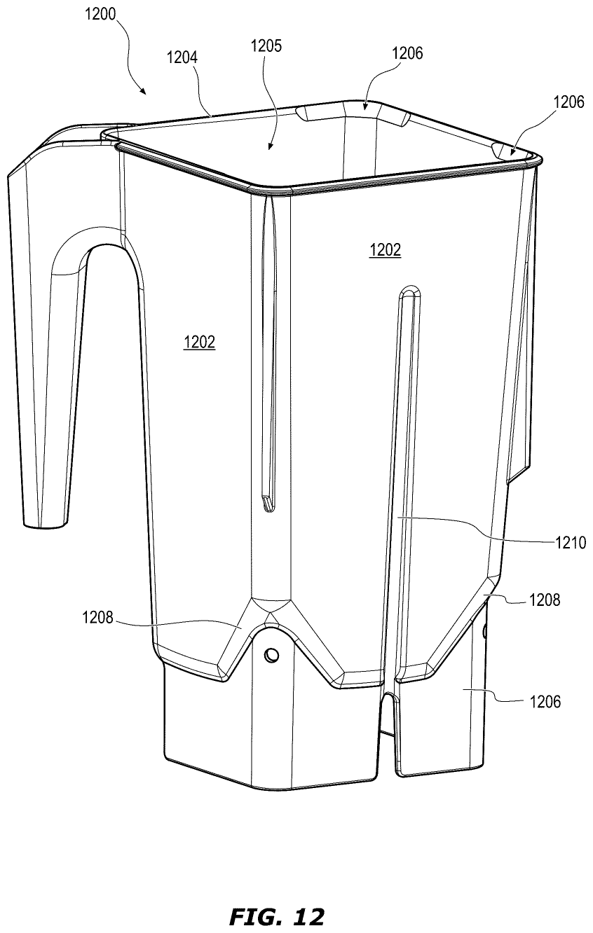

The blender apparatus 100 as shown in FIG. 1 and described above can be modified in a variety of ways. For example, the blender apparatus 100 can be implemented with a tamper or twister component, such as a ramrod-like stick that can be used to safely manipulate foodstuff during blending (e.g., by scraping blender jar sidewalls, mixing, stirring, etc.). As another example, the blender apparatus 100 can be implemented with an enclosure (e.g., a sound-attenuating enclosure) that can reduce operational noise of a housed blender. In yet another example, the blender apparatus 100 can be implemented without one or more components discussed above. For instance, the spout 116 can be removed or at least downsized (e.g., as shown in the embodiment depicted in FIGS. 12-14).

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

Various elements shown and described above can also be implemented in method steps for performing a method of blending foodstuff or a method of operating a blender apparatus. For example, a method of blending foodstuff can include: a first act of placing foodstuff into the interior volume 108 of the jar 102; a second act of at least partially enclosing the interior volume 108 by placing the cover 107 over the container walls 110; and a third act of effectuating the motor 120 via the controls 118 to cause the foodstuff to engage with the blade 104 and the flow manipulator(s) 112, wherein the flow manipulator(s) 112 can include a combination of corner occlusions and elongate ridges. Additional or alternative acts (and blender components) in such an example method can be implemented.

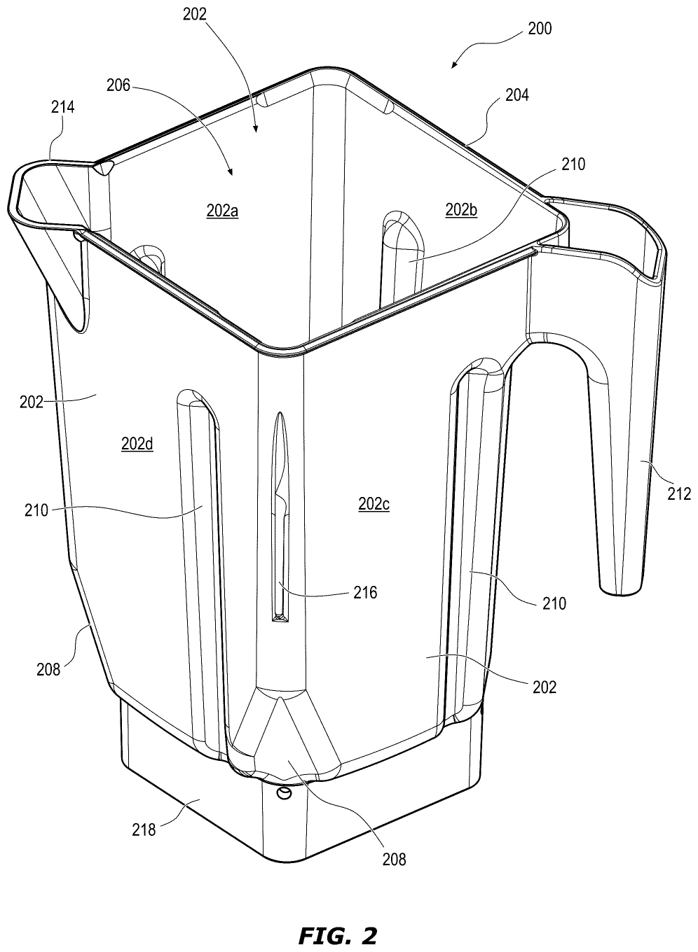

FIGS. 2-6 respectively illustrate perspective and various side views of an example blender jar 200 in accordance with one or more examples of the present disclosure. The blender jar 200 is an example implementation of the jar 102 discussed above in relation to FIG. 1. As shown, the blender jar 200 can include sidewalls 202, particularly sidewalls 202a-202d. The sidewalls 202 can be the same as or similar to the container walls 110 discussed above in relation to FIG. 1. In these or other examples, the sidewalls 202 can extend upward (e.g., relative to a container floor, not shown, or a base connector portion 218). The sidewalls 202 can at least partially define the metes and bounds of a jar interior 206 (e.g., the interior volume). In certain examples, the sidewalls 202 defines about a 1 quart-volume interior to about 10 quart-volume interior for the jar interior 206, as may be desired. The sidewalls 202 can include an upper periphery 204 (e.g., an uppermost perimeter edge) that defines an opening into the jar interior 206.

In some examples, the blender jar 200 can include chamfered portions 208. The chamfered portions 208 are one example of a flow manipulator (discussed above in relation to FIG. 1). As used herein, the term “chamfered portion” can refer to geometrically altered interior bottom corners of the jar interior 206. A chamfered portion need not be visible at an exterior surface of the sidewalls 202, although visible in some examples (e.g., as shown in FIGS. 2-6). For instance, the exterior surface of the sidewalls 202 can include unaltered corners, but the interior surface of the sidewalls 202 can nonetheless include chamfered portions. A chamfered portion is also not limited to a method of manufacturing. Although subtractive manufacturing methods (e.g., machining, finishing) are contemplated for the chamfered portions 208, those of ordinary skill in the art having the benefit of this disclosure will recognize that the chamfered portions 208 can be achieved via additional or alternative manufacturing methods—including additive manufacturing, injection molding, thermoforming, vacuum casting, extrusion, blow molding, rotational molding, compression molding, transfer molding, polymerization, etc.

The foregoing examples may apply to embodiments in which the chamfered portions 208 are integrally formed within the sidewalls 202 and/or the bottom wall (i.e., container floor, not shown) of the jar interior 206. This disclosure is not so limited. In at least one example, the chamfered portions 208 is instead attached (e.g., removably or permanently attached) to the sidewalls 202 and/or the bottom wall of the jar interior 206. For instance, the chamfered portions 208 can include an attachable insert, protrusion, implant, interlock, slide-in, or fastened element that is securable to the sidewalls 202 at bottom interior corners.

In one or more examples, the chamfered portions 208 can include corner occlusions. The term “corner occlusions” can refer to elements that hide, block, fill, seal off, encapsulate, or otherwise limit (or eliminate) fluid ingress to a corner. A corner occlusion can take on a variety of shapes, curvatures, angles, and/or surfaces. In some examples, a corner occlusion can be rounded (e.g., convex), sloped, pointed, etc. In particular examples, a corner occlusion can include a three-dimensional insert that is triangular-shaped, spherically shaped, rectangular shaped, cube shaped, cylindrical shaped, etc. In at least one example, a corner occlusion can displace a bottom interior corner of the jar interior 206 and substitute other geometry in its place.

The chamfered portions 208 can impart certain fluid flow effects (in addition to certain aesthetic characteristics). In some examples, the chamfered portions 208 positioned at bottom interior corners of the jar interior 206 can limit or prevent foodstuff from being trapped at corner regions outside a fluid flow (e.g., outside the mixing vortex)—thereby enhancing blending consistency and reducing blending time. That is, the chamfered portions 208 can increase a ratio of the mixing volume (covered by the vortex flow path) relative to a jar volume of the jar interior 206 so that more of the jar volume is efficiently utilized—or contributes to—mixing.

Additionally or alternatively, in some examples, the chamfered portions 208 can reduce the interior volume of the jar interior 206, but only at limited areas. For example, the jar interior 206 can be generally enlarged (e.g., maximized, optimized, or increased) for certain applications. However, the interior volume can be reduced adjacent the blade at a bottom region of the jar interior 206. In some examples, the reduced volume adjacent the blade at the bottom region of the jar interior 206 can improve blending consistency (and reduce blending time) specifically for blending lower volumes of foodstuff, while the overall blending capacity of the chamfered portions 208 is not compromised.

Traditional blender jars have, in contrast to the disclosed jars, substantially reduced the overall capacity of the blender jar in order to blend extra small volumes of foodstuff (e.g., less than 10 fluid ounces). Larger volume blender jars existing in the art, in general, cannot blend extra small volumes of foodstuff (e.g., less than 10 fluid ounces)—due at least in part because the smaller volume of foodstuff can become trapped in corners or be thrown out of the mixing vortex. The chamfered portions 208 of the present disclosure can, thus, obviate existing blender jars that can only mix a small, limited range of a larger mixing volume spectrum. For instance, some existing small blender jars may blend around 8 fluid ounces to about 12 fluid ounces, but not more and not less. On the other hand, some existing larger blender jars may blend around 15 fluid ounces to about 35 fluid ounces, but not more and not less. These examples constitute discrete jars with corresponding discrete subsets of blending volume range. In comparison, the blender jar 200 of the present disclosure can blend a more expansive blending volume spectrum (e.g., between about 4 fluid ounces and about 80 fluid ounces) that has heretofore been achieved by a single blender jar.

In some examples, the blender jar 200 can include elongate ridges 210 positioned on one or more interior surfaces of the sidewalls 202. The term “elongate ridge” can refer to an interior-facing protrusion, rib, bump, knob, hump, jut, projection, protuberance, shelf, bulge, or swelling having a largest dimension being its height (i.e., length) measured in a same or similar direction corresponding to a jar height of the blender jar 200. In particular examples, an elongate ridge (like the chamfered portions 208) need not be visible from an exterior surface of the sidewalls 202. However, as shown in FIGS. 2-6, some embodiments of an elongate ridge are visible from the exterior surface of the sidewalls 202. In some examples, the elongate ridges 210 can be integrally formed within the sidewalls 202 (e.g., molded into the sidewalls 202). In other examples, the elongate ridges 210 can be attached (e.g., fastened, adhered, or otherwise secured) to the sidewalls 202. The elongate ridges 210 can have a variety of shapes, sizes, cross-sectional profiles, and positional configurations within the jar interior 206, as will be discussed below.

In addition, the elongate ridges 210 can impart certain flow characteristics. For example, the elongate ridges 210 can divert flow, change flow direction, disrupt flow, and/or provide impact surfaces. In particular examples, the elongate ridges 210 can add fluid resistance by slowing the fluid rotational velocity. This slowing of the rotational fluid velocity can increase the disparity between the blending blade velocity and the fluid velocity, thereby improving blending consistency and shortening blending time. In some examples, the elongate ridges 210 can be asymmetrically arranged relative to an axis of rotation of the blending blade. The reflective asymmetry may introduce turbulence to the motion of the foodstuff and increase the probability that the foodstuff will come into contact with the blade rather than being swept around the blade or into a neutral portion of the blender jar 200 by the flow. In certain examples, the elongate ridges 210 can work together to provide an accumulative effect that builds upon the previous ridge's effect (e.g., increasing turbulence, vorticity, movement, etc.).

In at least one example, the elongate ridges 210 can impart certain flow characteristics at specific regions within the jar interior 206. For example, at lower regions of the jar interior 206, the elongate ridges 210 can induce specific levels of turbulence and/or induce a specific flow path in which fluid is deflected away from sidewalls 202 and inward toward the blending blade. As another example, at higher regions of the jar interior 206, the elongate ridges 210 can induce another level of turbulence and/or another flow path (e.g., that is different than the level of turbulence and/or the flow path at lower regions of the jar interior 206). For instance, at higher regions of the jar interior 206 (e.g., where the mixing vortex is comparatively larger and has a slower velocity than at lower regions adjacent the blending blade), the elongate ridges 210 can induce certain eddies, vortices, and/or other fluid interactions that penetrate deeper into the mixing vortex. In some examples, the free-stream velocity and/or other aspects of the mixing vortex at higher regions of the jar interior 206 can be more greatly affected by the elongate ridges 210 than at lower regions of the jar interior 206. The elongate ridges 210 can, therefore, improve a consistency of a blended product and/or improve a blending time, particularly when blending higher volumes of foodstuff (e.g., in excess of about 40 fluid ounces, between about 40 fluid ounces and about 120 fluid ounces, between about 60 and about 100 fluid ounces, or between about 70 and 90 fluid ounces).

In at least some examples, the chamfered portions 208 and the elongate ridges 210—in combination—can provide unique advantages that have heretofore been unachieved, particularly by using a single blender jar. For example, the chamfered portions 208 can decrease a blending time and/or increase a blending consistency for smaller volumes of foodstuff, while the elongate ridges 210 can likewise decrease a blending time and/or increase a blending consistency for higher volumes of foodstuff. In particular examples, the chamfered portions 208 and the elongate ridges 210 work together to provide a more potent mixing effect than when utilized alone (i.e., one without the other).

For example, experimental data indicates that—for a disclosed blender jar embodiment implementing the chamfered portions 208 versus an existing blender jar with “no chamfer”—the chamfered portions 208 can provide an approximate 24% decrease in average particle size diameter. In addition, experimental data indicates that—for a disclosed blender jar embodiment implementing the elongate ridges 210 (elongated in height and increased in one or both of lateral width or cross-sectional thickness) versus an existing blender jar with comparatively smaller interior ridges—the elongate ridges 210 can provide an approximate 82% decrease in average particle size diameter. Further experimental data indicates that combining the chamfered portions 208 and the elongate ridges 210 can provide an approximate 11% additional decrease in average particle size compared to an embodiment implementing the elongate ridges 210 without the chamfered portions 208. Thus, in some embodiments, combining the chamfered portions 208 and the elongate ridges 210 can provide enhanced blending consistency for a same or even shorter blending duration. Experimental data indicates, in particular, that existing blenders may achieve acceptable blending consistency in about 12 seconds to about 18 seconds. However, the chamfered portions 208 and the elongate ridges 210 of the present disclosure, can provide comparatively better blending consistency (i.e., smaller average particle size diameters) in about 6 seconds according to experimental data—which is about a 50% to 66% decrease in blending time with improved blending consistency. That is, the chamfered portions 208 and the elongate ridges 210 can provide a more uniform blending consistency in which particle sizes are substantially equivalent (e.g., within +/−10%) of an average particle size diameter that is smaller than existing blenders can achieve, and this feat can be achieved in about 6 seconds of blending. In many instances (and for most variety of foodstuff), no more than 10 seconds of blending is required to achieve uniform blending consistency because of the chamfered portions 208 and the elongate ridges 210.

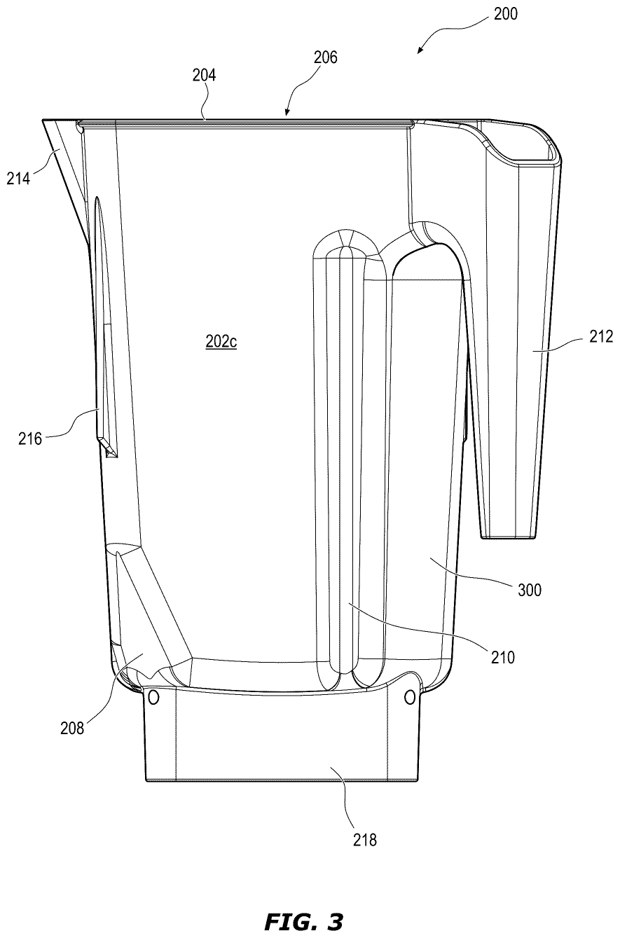

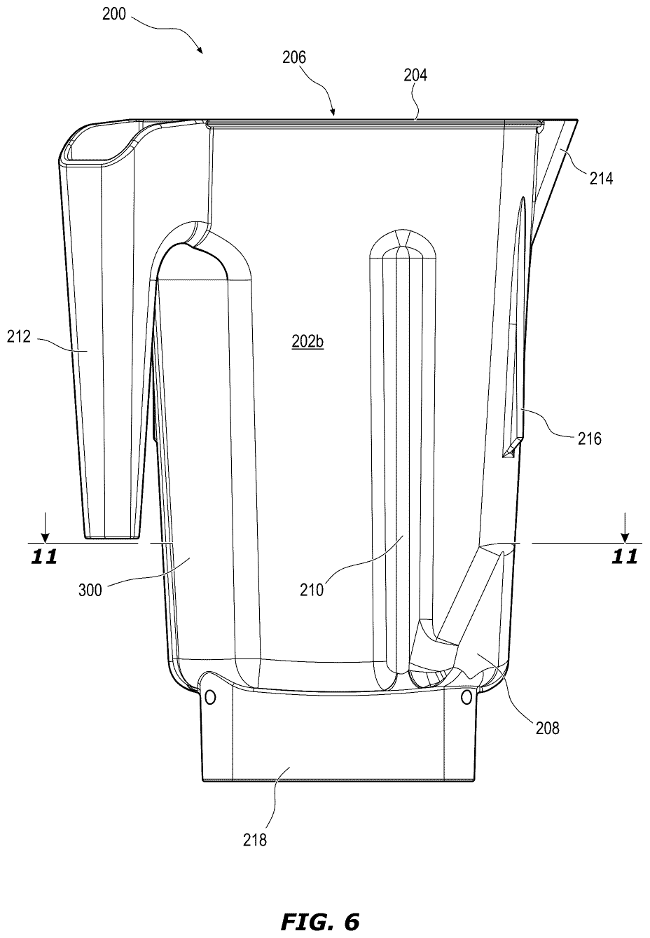

Other features of the blender jar 200 can also affect blending consistency and/or blending time. For example, and as shown in FIGS. 3 and 6, the blender jar 200 can include a truncated wall 300. The truncated wall 300, in some examples, can further deflect, redirect, or alter fluid flow within the jar interior 206. In certain implementations, the truncated wall 300 can shift the vortex of materials in the jar interior 206 to drive the materials toward the blending blade more consistently.

The truncated wall 300 can be arranged in a variety of ways. The truncated wall 300 can include an additional container wall that spans between two adjacent sidewalls (e.g., the sidewall 202b and the sidewall 202c). In some examples, the truncated wall 300 can be positioned closer to a central axis of the blender jar 200 than the sidewalls 202. In certain examples, the truncated wall 300 can be positioned adjacent to a jar handle. In these or other examples, the truncated wall 300 can be asymmetrically positioned between two adjacent sidewalls.

Other features of the blender jar 200 are also shown in FIGS. 2-6. For example, the blender jar 200 can include a handle 212 (e.g., for carrying and/or holding the blender jar 200). In certain examples, the handle 212 can include a hollow portion so that additional blender jars 200 can be stacked and nested in the jar interior 206 and the hollow portion of the handle 212. The blender jar 200 can additionally include a spout 214. The spout 214 can include a guide or channel that facilitates convenient pouring of blended contents from the jar interior 206.

In some examples, the blender jar 200 can include one or more ribs 216. The ribs 216 can be positioned at various exterior locations along the sidewalls 202. In certain implementations, the ribs 216 can control a nesting depth of the blender jar 200 when stacked inside another blender jar 200 (e.g., to help ensure blender jars are not stuck together for convenient removal from a nested stack of blender jars). Thus, in some embodiments, the ribs 216 can taper from a largest portion (e.g., a most pronounced ajutment relative to the sidewalls 202) at the bottom to a smallest ajutment portion at the top.

The blender jar 200 can additionally include a base connector portion 218. The base connector portion 218 can include a bottom exterior of the blender jar 200 for connecting to a base (e.g., the base 106 discussed above in relation to FIG. 1). In some examples, the base connector portion 218 can rest atop a blender base, sealingly engage with a blender base, interlock with a blender base, etc. In certain examples, the base connector portion 218 can define a receptacle sized and shaped to receive the blender base (e.g., for mating the blending blade assembly with the motor driveshaft).

Any of the features, components, and/or parts, including the arrangements and configurations thereof shown in FIGS. 2-6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2-6.

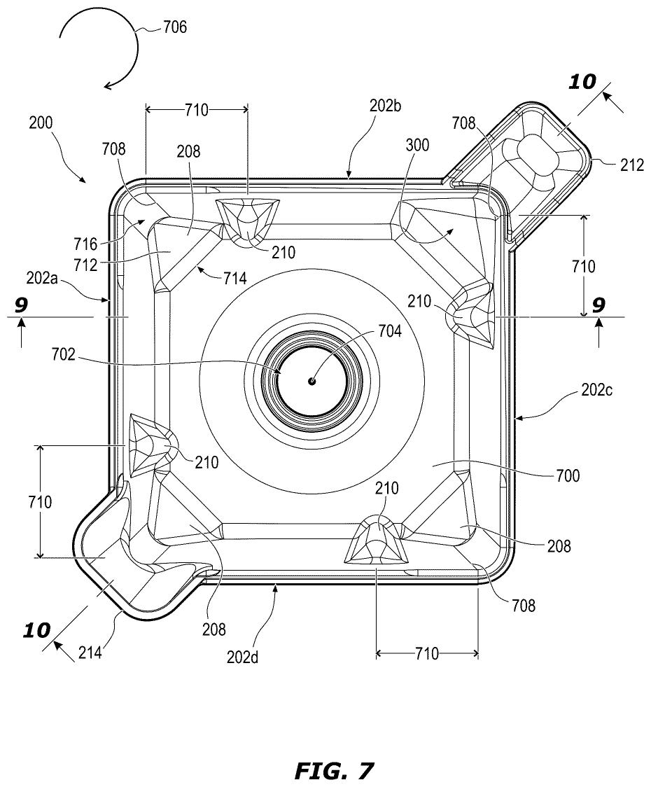

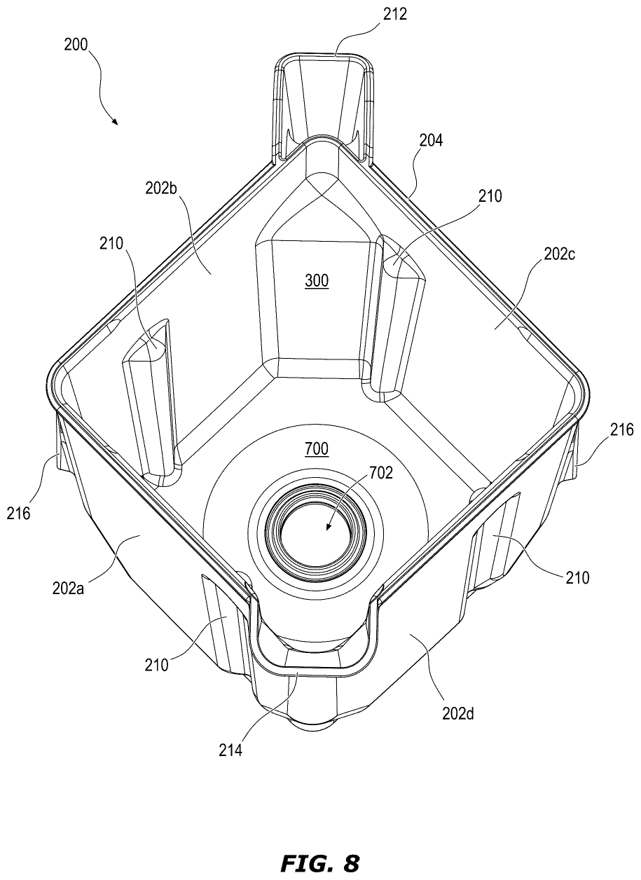

FIGS. 7-11 illustrate additional views of the blender jar 200 in accordance with one or more examples of the present disclosure. In particular, FIG. 7 illustrates a top plan view of the blender jar 200, and FIG. 8 illustrates a top perspective view of the blender jar 200. As shown, the jar interior 206 is defined in part by a bottom wall 700 (e.g., a floor of the blender jar 200 at a bottom container end opposite the upper periphery 204 at the other container end). In some examples, the bottom wall 700 defines an opening 702. In these or other examples, the opening 702 can be sized and shaped to receive a blending blade assembly, including a blending blade that can rotate (e.g., in a direction 706) about an axis of rotation 704.

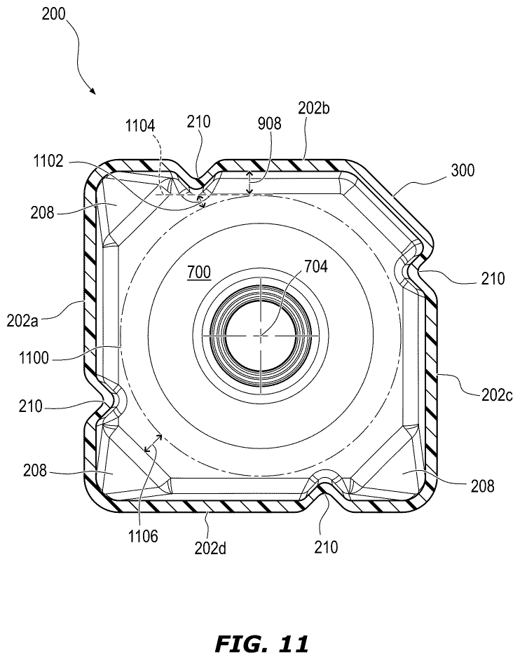

Additionally shown, the chamfered portions 208 and the elongate ridges 210 are depicted in a particular example of a certain positional configuration and structural arrangement (albeit others are herein contemplated and described below in relation to FIGS. 12-17). In the illustrated embodiment, the elongate ridges 210 are spaced apart from leading edges 708 of each sidewall 202 by a distance 710. The leading edges 708 can refer to the corner edge (e.g., fillet edge) closest to the elongate ridges 210. Additionally or alternatively, the leading edges 708 can include the specific corner edges that—for each respective sidewall 202—are in relative proximity to the blending blade (not shown) before the subsequent trailing edge opposite the leading edge 708—as the blending blade rotates around in the direction 706. Specifically, the distance 710 can ensure the elongate ridges 210 are not only positioned off-center of the sidewalls 202, but also positioned closer to the leading edges 708. As will be discussed below in relation to FIG. 11, the distance 710 can also affect an amount of clearance between the blending blade and the elongate ridges 210. In certain examples, the distance 710 can range from about 0.2 inches to about 5 inches, about 0.5 inches to about 4 inches, about 1 inch to about 3 inches, or about 2 inches to about 2.5 inches.

In some examples, this asymmetrical positioning of the elongate ridges 210 can enhance blending consistency and/or decrease blending time. For example, the closer arrangement of the elongate ridges 210 to the leading edge 708 for each sidewall 202 can result in a fluid flow manipulation that occurs before the centerline of each sidewall. The earlier-induced fluid flow manipulation can create a fluid flow effect that—with greater efficiency—carries into the blending blade (e.g., by accounting for the momentum of the fluid flow that laterally sweeps a fluid flow effect, such as fluid eddies). Conversely, a fluid flow manipulation that is dead center of a sidewall 202 (or positioned past center so as to be closer to the trailing edge than the leading edge 708) can result in a fluid flow effect that does not carry into the blending blade with a desired efficiency. For instance, induced vortices from the elongate ridges 210 may only partially interact—or interact to a lesser degree—with the blending blade when the elongate ridges 210 are positioned dead center of a sidewall 202 or closer to the trailing edge than the leading edge 708.

Further shown, each of the elongate ridges 210 can be positioned adjacent to and clockwise from one of the chamfered portions 208 or the truncated wall 300. In this positioning, respective pairs of the elongate ridges 210 and the chamfered portions 208/truncated wall 300 can—in combination—provide an improved fluid flow manipulation heretofore unachieved by existing blenders. For example, a fluid flow can impact a transition wall 712 (e.g., an impact surface of the chamfered portions 208 that spans between a base 714 adjoining the bottom wall 700 and a top 716 adjoining adjacent sidewalls 202). At impact with the transition wall 712, the fluid flow can be redirected into the elongate ridges 210 where the fluid flow is again manipulated (e.g., by causing enlarged fluid eddies that are swept directly into the blending blade). In some examples, the chamfered portions 208 can increase an amount of fluid flow that contacts the elongate ridges 210 (e.g., by deflecting or guiding fluid flow into the elongate ridges 210). Thus, in some embodiments, a fluid flow effect induced by the elongate ridges 210 can be enhanced due to the chamfered portions 208 increasing the efficiency of fluid interaction with the elongate ridges 210. In turn, the elongate ridges 210 can direct the fluid flow (e.g., a manipulated fluid flow) toward the blending blade. Likewise, the truncated wall 300 can provide a same or similar effect as described above when paired with its adjacent elongate ridge 210.

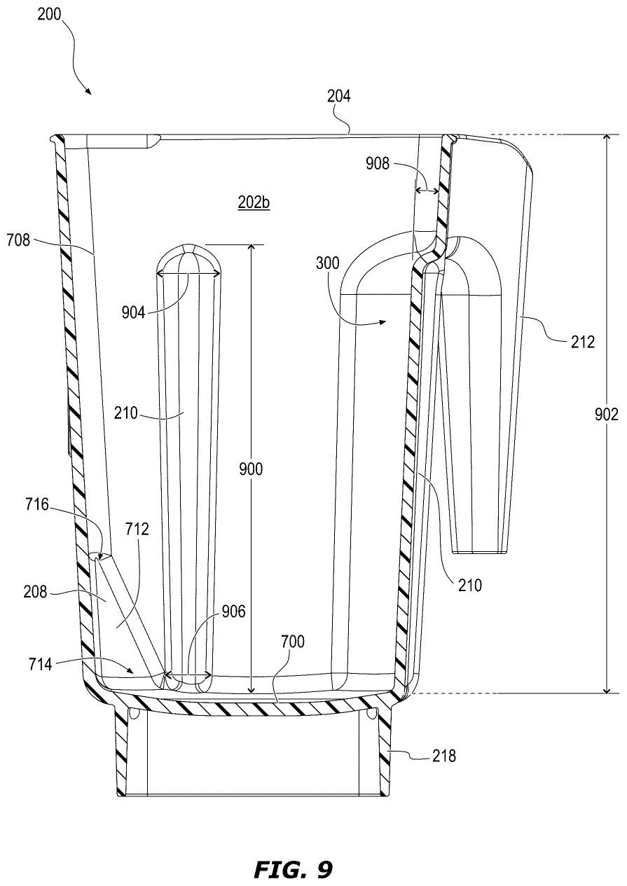

FIG. 9 illustrates a cross-sectional view of the blender jar 200 extending through one of the elongate ridges 210, while also depicting a plan view of another of the elongate ridges 210. As shown, the elongate ridges 210 can include a ridge height 900. In some examples, the ridge height 900 can be at least half of a height 902 of the jar interior 206. In particular examples, the ridge height 900 is about 50% to about 95% of the height 902, about 60% to about 85% of the height 902, or about 70% to about 80% of the height 902. In at least one example, when foodstuff is added into the jar interior 206, the ridge height 900 can exceed a foodstuff height corresponding to approximately 36 fluid ounces. In these or other examples, the increased height of the ridge height 900 can facilitate fluid flow manipulations for correspondingly increased amounts of blending volumes (e.g., greater than about 40 fluid ounces).

Height of the elongate ridges 210 is just one example design factor for tuning fluid flow manipulations. Width of the elongate ridges 210 (measured laterally from side-to-side of the elongate ridges 210) can also affect how fluid flow is manipulated. In some examples, the width of the elongate ridges 210 is constant from top to bottom. In other examples, and as shown, the elongate ridges 210 can include a tapered cross-section with a top width 904 that is wider than a bottom width 906. In some examples, the top width 904 is wider than the bottom width 906 to compensate for the larger fluid volume at the top of the jar interior 206.

Depth or thickness of the elongate ridges 210 (measured perpendicular to the interior surface of the sidewalls 202) is yet another design factor that can affect fluid flow manipulation. As shown, the elongate ridges 210 can include a depth 908 at which the elongate ridges 210 protrudes inward toward the center of the jar interior 206. In some examples, the depth 908 is constant. In other examples, the depth 908 varies as a function of the ridge height 900. In certain examples, the depth 908 can also be tuned based on a positional relationship to the blending blade (e.g., as will be described below in relation to FIG. 11).

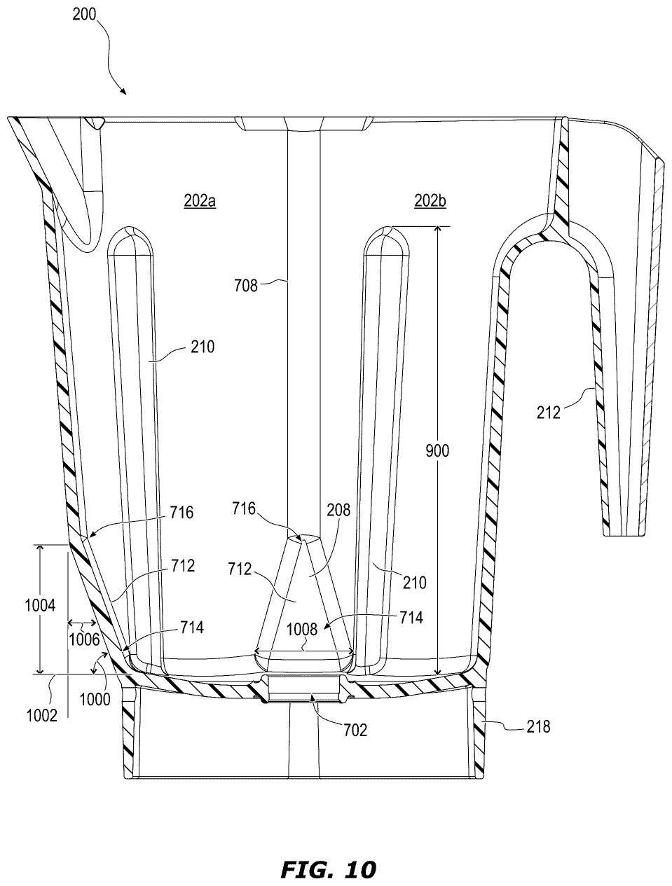

FIG. 10 illustrates a cross-sectional view of the blender jar 200 extending through one of the chamfered portions 208, while also depicting a plan view of another of the chamfered portions 208. As shown, the chamfered portions 208 can be positioned at an angle 1000 relative to a reference plane 1002. The reference plane 1002 can be a horizontal reference plane (e.g., coplanar with the bottom wall 700 or substantially parallel and adjacent to the bottom wall 700). In these or other examples, the angle 1000 can be between about 5 degrees and about 85 degrees, between about 15 degrees and about 75 degrees, between about 20 degrees and about 70 degrees, between about 30 degrees and about 60 degrees, or between about 45 degrees and about 55 degrees. Those of ordinary skill in the art having the benefit of this disclosure will recognize that, although the angle 1000 relates the reference plane 1002 to an exterior surface of the sidewall 202, the foregoing examples of the angle 1000 can be mathematically adjusted to relate the transition wall 712 of the interior surface to the reference plane 1002 (e.g., by subtracting the foregoing example exterior angles from 180 degrees to get the interior angle of the chamfered portions 208).

Further shown, the chamfered portions 208 can include a height 1004 measured relative to the reference plane 1002. In some examples, the height 1004 can extend up to half of the height 902, and in some instances greater than half of the height 902. In particular examples, however, the height 1004 is about 15% to about 45% of the height 902, about 20% to about 40% of the height 902, or about 25% to about 35% of the height 902.

The chamfered portions 208 can extend inward relative to the sidewalls 202 by an inward distance 1006. The inward distance 1006 can be sized according to a desired clearance or gap relative to the blending blade (as will be discussed more in relation to FIG. 11). In particular examples, the chamfered portions 208 can be sized, shaped, and positioned such that the inward distance 1006 tapers with increasing height of the chamfered portions 208 and lateral distance away from the blending blade (or the blade perimeter).

In addition, the chamfered portions 208 can include a base width 1008 at the base 714. The base width 1008 is measured laterally side-to-side of the interior volume 108. In particular examples, the base width 1008 can be sized according to a proximity of the chamfered portions 208 relative to the elongate ridges 210. For example, the base width 1008 can be larger when the distance 710 (shown in FIG. 7) is greater, and the base width 1008 can be smaller when the distance 710 is lesser. In certain implementations, the base width 1008 is sized based on the lateral dimensions of the sidewalls 202 (e.g., such that wider sidewalls can allow a larger base width 1008 and narrower sidewalls allow a smaller base width 1008).

In some examples, at least one of the angle 1000, the height 1004, the inward distance 1006, or the base width 1008 can affect fluid flow manipulations within the jar interior 206. For example, the foregoing dimensions and angular pitch of the chamfered portions 208 can affect how a fluid flow impacts the transition wall 712 and/or how a fluid flow is deflected from the transition wall 712 (e.g., inducing a type or direction of fluid flow manipulation). Similarly, the foregoing dimensions and angular pitch of the chamfered portions 208 can affect a volume of fluid flow manipulation (e.g., how much fluid flow impinges upon the transition wall 712 and/or subsequently impinges upon the elongate ridges 210).

FIG. 11 illustrates a top cross-sectional view of the blender jar 200. As shown, the blender jar 200 can include a blade perimeter 1100 along which the outermost edge of a blending blade can travel. As discussed above, the elongate ridges 210 can be sized, shaped, and positioned relative to other components of the blender jar 200, including a blending blade. In some examples, the elongate ridges 210 can be spaced apart from the blade perimeter 1100 by a clearance gap 1102. The clearance gap 1102 can refer to a distance to the blade perimeter 1100 measured from the elongate ridges 210 (specifically at the tangent point of contact to a plane 1104 tangent to the elongate ridges 210). In one or more examples, the clearance gap 1102 can be tuned to promote a particular fluid flow and/or certain characteristics of a fluid flow (e.g., vortex velocity). In certain examples, the clearance gap 1102 can be tuned to more efficiently sweep a fluid flow manipulation inside the blade perimeter 1100. In these or other examples, the distance 710 and/or the depth 908 can affect the clearance gap 1102.

As also discussed above, the chamfered portions 208 can be sized, shaped, and positioned relative to other components of the blender jar 200, including a blending blade. In some examples, the chamfered portions 208 can be spaced apart from the blade perimeter 1100 by a distance 1106. The distance 1106 can include a clearance distance from the blade perimeter 1100 that can be tuned to promote a particular fluid flow and/or certain characteristics of a fluid flow (e.g., vortex velocity). In certain examples, the distance 1106 can be tuned to more efficiently direct a fluid flow into the elongate ridges 210. In specific implementations, the distance 1106 can be tuned to adjust an angle at which fluid flow impinges the elongate ridges 210. In these or other examples, the angle 1000 and/or the inward distance 1006 can affect the distance 1106 separating the chamfered portions 208 from the blade perimeter 1100.

Any of the features, components, and/or parts, including the arrangements and configurations thereof shown in FIGS. 7-11 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 7-11.

FIGS. 12-14 respectively illustrate perspective, top, and perspective cross-sectional views of an example blender jar 1200 in accordance with one or more examples of the present disclosure. The blender jar 1200 is an example implementation of the jar 102 discussed above in relation to FIG. 1. Certain features of the blender jar 1200 can be the same as or similar to the features discussed above in relation to the blender jar 200 shown in FIGS. 2-11. Other features of the blender jar 1200—which may be present in the blender jar 200—can be modified or omitted. For example, being a comparatively smaller-volume jar than the blender jar 200, the blender jar 1200 can include various modifications and/or omissions that promote certain fluid flow conditions and/or are adapted for a specific blending application (e.g., frothing a cold beverage, mixing spices, etc.).

As shown, the blender jar 1200 can include sidewalls 1202 extending upward and defining an upper periphery 1204 and an interior volume 1205. In particular examples, and in lieu of a spout, the upper periphery 1204 can include pouring regions 1206 that include beveled edges for convenient pouring at one or more different areas along the upper periphery 1204.

Additionally shown, the blender jar 1200 can include chamfered portions 1208 and elongate ridges 1210, similar to those discussed above. The chamfered portions 1208 can be similarly positioned at bottom interior corner regions of the interior volume 1205 and perform the same or similar functions explained in the foregoing description. In particular, the chamfered portions 1208 can be spaced apart a distance 1312 from a blade perimeter 1310, similar to the spatial positioning of the chamfered portions 208.

Regarding the elongate ridges 1210, however, the elongate ridges 1210 can include a different asymmetrical positional configuration than the elongate ridges 210. For example, one of the elongate ridges 1210 can be positioned on a truncated wall 1300 instead of a sidewall 1202 (e.g., to promote a particular fluid flow and/or certain characteristics of a fluid flow). As another example, others of the elongate ridges 1210 can be longitudinally positioned on the sidewalls 1202 at locations closer to central axes 1302 than were the depicted examples of the elongate ridges 210 of the blender jar 200 (albeit still off-center). In particular, some of the elongate ridges 1210 can be spaced apart a distance 1304 from leading edges 1306. The distance 1304 at which the elongate ridges 1210 are positioned from the leading edges 1306 can impart a different fluid flow and/or different characteristics of a fluid flow in comparison to the distance 710 of the blender jar 200. In some examples, a gap 1308 between the elongate ridges 1210 and a blade perimeter 1310 can be tuned (e.g., such that a fluid flow manipulation caused by impingement at the elongate ridges 1210 is efficiently directed into the blade perimeter 1310). Additionally or alternatively, a curvature and/or shape of the elongate ridges 1210 can be modified to compensate for the comparatively increased distance from the leading edges 1306 (e.g., such that a fluid flow manipulation is efficiently directed into the blade perimeter 1310).

Any of the features, components, and/or parts, including the arrangements and configurations thereof shown in FIGS. 12-14 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 12-14.

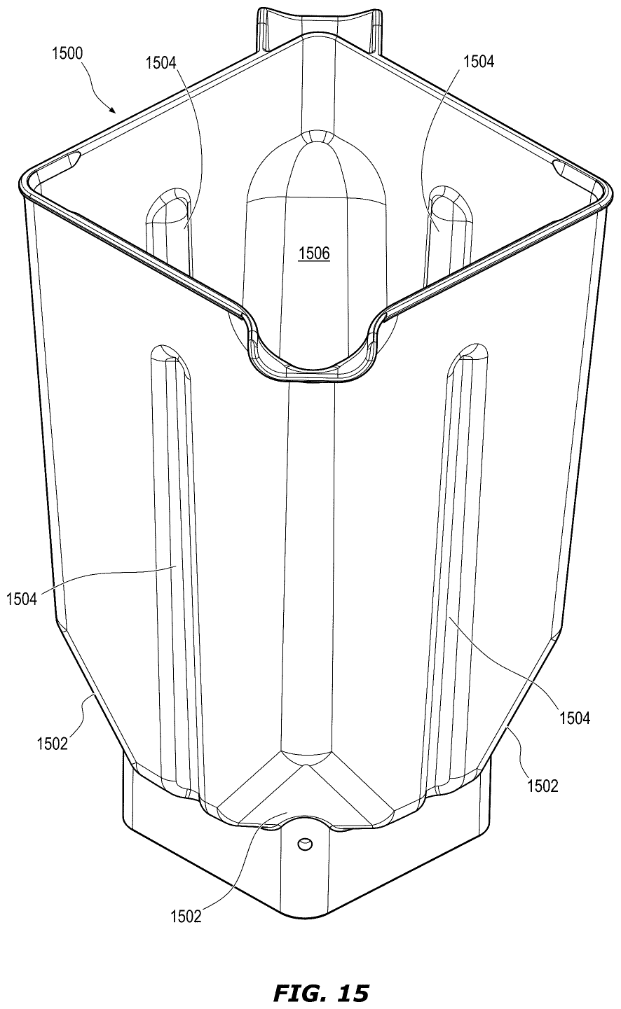

FIGS. 15-17 respectively illustrate perspective, top, and perspective cross-sectional views of another example blender jar 1500 in accordance with one or more examples of the present disclosure. The blender jar 1500 is another example implementation of the jar 102 discussed above in relation to FIG. 1. Certain features of the blender jar 1500 can be the same as or similar to the features discussed above in relation to the blender jar 200 shown in FIGS. 2-11 and/or the features discussed above in relation to the blender jar 1200 shown in FIGS. 12-14. Other features of the blender jar 1500—which may be present in at least one of the blender jar 200 or the blender jar 1200—can be modified or omitted. For example, being a comparatively larger-volume jar than the blender jar 200 and the blender jar 1200, the blender jar 1500 can include various modifications and/or omissions that promote certain fluid flow conditions and/or are adapted for a specific blending application (e.g., blending large volumes of smoothies between about 40 fluid ounces and about 80 fluid ounces).

As shown, the blender jar 1500 can include chamfered portions 1502, elongate ridges 1504, and a truncated wall 1506, similar to those discussed above. Like the chamfered portions 208 and the chamfered portions 1208, for instance, the chamfered portions 1502 can be similarly positioned at bottom interior corner regions of the blender jar 1500 and perform the same or similar functions explained in the foregoing description. In particular, the chamfered portions 1502 can be spaced apart a distance 1614 from a blade perimeter 1612, similar to the spatial positioning of the chamfered portions 208 and the chamfered portions 1208.

Regarding the elongate ridges 1504, however, the elongate ridges 1504 can include a different asymmetrical positional configuration than the elongate ridges 210 and the elongate ridges 1210. For example, each of the elongate ridges 1504 can be longitudinally positioned on the sidewalls at locations adjacent to and rotationally forward of central axes 1604 at a distance 1606 away from leading edges 1608. The distance 1606 at which each of the elongate ridges 1504 are positioned from the leading edges 1608 can impart a different fluid flow and/or different characteristics of a fluid flow in comparison to the distance 710 of the blender jar 200. In addition, each sidewall having one of the elongate ridges 1504 (and the truncated wall 1506 omitting one of the elongate ridges 1504) can impart a different fluid flow and/or different characteristics of a fluid flow in comparison to the elongate ridges 1210 of the blender jar 1200.

In some examples, a gap 1610 between the elongate ridges 1504 and a blade perimeter 1612 of a rotatable blade 1602 can be tuned (e.g., such that a fluid flow manipulation caused by impingement at the elongate ridges 1504 is efficiently directed into the blade perimeter 1612 for interactions with the blade 1602). Additionally or alternatively, a curvature and/or shape of the elongate ridges 1504 can be modified to compensate for the comparatively increased distance from the leading edges 1608 (e.g., such that a fluid flow manipulation is efficiently directed into the blade perimeter 1612 for interactions with the blade 1602).

Any of the features, components, and/or parts, including the arrangements and configurations thereof shown in FIGS. 15-17 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 15-17.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed.

It will be apparent to one of ordinary skill in the art that many modifications and variations are possible in view of the above teachings. Indeed, various inventions have been described herein with reference to certain specific aspects and examples. However, they will be recognized by those skilled in the art that many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.” Additionally, the terms “about,” “approximately,” and “substantially” should be interpreted as +/−10 percent of a given value, unless otherwise indicated.

What is claimed is:

1. A blender jar, comprising:
a bottom wall;
a plurality of sidewalls extending upward from the bottom wall and defining a jar interior, an upper periphery of the plurality of sidewalls defining an opening into the jar interior; and
a plurality of chamfered portions respectively positioned at a plurality of corners adjoining the bottom wall and a pair of adjacent sidewalls of the plurality of sidewalls.

2. The blender jar of claim 1, wherein the blender jar is configured to blend foodstuff having a volume of about 4 fluid ounces to about 10 fluid ounces.

3. The blender jar of claim 2, wherein the foodstuff comprises a substantially uniform blending consistency after about six seconds of blending.

4. The blender jar of claim 1, wherein each chamfered portion of the plurality of chamfered portions comprises a transition wall having an angle greater than 20 degrees relative to the bottom wall.

5. The blender jar of claim 1, wherein each chamfered portion of the plurality of chamfered portions comprises a triangular-shaped transition wall.

6. The blender jar of claim 1, wherein each chamfered portion of the plurality of chamfered portions comprises a base adjoining the bottom wall and a top adjoining the pair of adjacent sidewalls, the base being wider than the top.

7. The blender jar of claim 1, further comprising elongate ridges extending vertically from the bottom wall toward the upper periphery.

8. The blender jar of claim 7, wherein during blending, each chamfered portion of the plurality of chamfered portions directs a fluid flow into an adjacent elongate ridge of the elongate ridges.

9. A blender apparatus, comprising:
a base comprising:
a motor; and
one or more controls to effectuate the motor;
a blade rotatably connected to the motor about an axis of rotation; and
a container positionable on the base and comprising an interior volume around the blade, the container comprising:
a floor positioned at a first container end;
a plurality of sidewalls extending away from the floor toward a second container end opposite the first container end; and
a plurality of elongate ridges extending between the first container end and the second container end, each elongate ridge of the plurality of elongate ridges being asymmetrically positioned relative to the axis of rotation and extending at least half of a height of the interior volume.

10. The blender apparatus of claim 9, wherein the blender apparatus is configured to blend foodstuff having a volume of up to about 80 fluid ounces.

11. The blender apparatus of claim 10, wherein during blending, the foodstuff is configured to form a fluid flow that impinges upon the plurality of elongate ridges and achieves a uniform blending consistency in about ten seconds or less.

12. The blender apparatus of claim 9, wherein the plurality of elongate ridges is configured to manipulate flow at an upper portion of the plurality of sidewalls adjacent the second container end.

13. The blender apparatus of claim 9, wherein each elongate ridge of the plurality of elongate ridges is respectively positioned equidistant from leading sidewall edges of the plurality of sidewalls.

14. The blender apparatus of claim 9, further comprising a truncated wall between a pair of sidewalls of the plurality of sidewalls.

15. The blender apparatus of claim 14, further comprising an additional elongate ridge positioned on the truncated wall.

16. The blender apparatus of claim 9, further comprising a plurality of corner occlusions respectively positioned between the floor and pairs of adjacent sidewalls of the plurality of sidewalls.

17. A blender apparatus, comprising:
a base comprising:
a motor; and
one or more controls to effectuate the motor;
a blade rotatably connected to the motor; and
a container positionable on the base and comprising an interior volume around the blade, the container comprising:
a first container end;
a second container end opposite the first container end;
a plurality of interior sidewalls spanning between the first container end and the second container end;
a first plurality of flow manipulators extending longitudinally between the first container end and the second container end; and
a second plurality of flow manipulators separate from the first plurality of flow manipulators and positionable adjacent the blade, the second plurality of flow manipulators being attached to the plurality of interior sidewalls and extending inward in a direction toward the blade.

18. The blender apparatus of claim 17, wherein the second plurality of flow manipulators comprises corner occlusions that extend between adjacent interior sidewalls of the plurality of interior sidewalls.

19. The blender apparatus of claim 17, wherein each flow manipulator of the second plurality of flow manipulators tapers with increasing height and lateral distance away from the blade.

20. The blender apparatus of claim 17, wherein during blending:
each flow manipulator of the first plurality of flow manipulators is configured to direct a fluid flow into an adjacent flow manipulator of the second plurality of flow manipulators; and
each flow manipulator of the second plurality of flow manipulators is configured to direct the fluid flow toward the blade.
